(19) United States
(12) Patent Application Publication
(10) Pub. No.: US 2014/0197365 A1
(43) Pub. Date: Jul. 17, 2014

(54) ELECTRICALLY CONDUCTIVE PULP AND METHOD OF MAKING

(71) Applicants: Gary Delmar Jaycox, West Chester, PA (US); Jeffrey S. Downey, Battersea (CA)

(72) Inventors: Gary Delmar Jaycox, West Chester, PA (US); Jeffrey S. Downey, Battersea (CA)

(73) Assignee: E I DU PONT DE NEMOURS AND COMPANY, Wilmington, DE (US)

(21) Appl. No.: 13/743,779

(22) Filed: Jan. 17, 2013

(51) Int. Cl. C08L 79/02

(52) U.S. Cl. CPC C08L 79/02
USPC 252/500; 560/38

(57) ABSTRACT

An electrically conductive pulp suitable for use as a reinforcement comprises from 60 to 96 weight percent of fibers of aromatic polyamide, aromatic copolyamide or mixtures thereof and from 4 to 40 weight percent of conductive material coated onto the fibers wherein the conductive material comprises (i) a polymer of aniline, or (ii) a random copolymer formed from aniline and one or more substituted aniline co-monomers that exist in the protonated emeraldine salt form.

### BACKGROUND

1. Field of the Invention

This invention pertains to electrically conductive pulp, a method of making the pulp and compounds formed during the making of the pulp.

2. Description of Related Art

Short length para-aramid fibers in pulp form are well suited as matrix reinforcing materials and find increasing application in various mechanical rubber goods such as tires, belts and hoses. The non-conductive behavior of para-aramid pulp necessitates the use of carbon black particles as an additional additive in rubber formulations when electrical conductivity properties are required. Conductive carbon blacks are required to dissipate static charge build-up that naturally occurs in a rolling tire. Unfortunately, the unwanted aggregation of carbon black particles within the tire “matrix” leads to heat build-up and other deleterious effects that increase tire rolling resistance. There is therefore a need to provide para-aramid type pulp in an electrically conductive form and eliminate the addition of carbon black in the rubber formulation.

U.S. Pat. No. 6,436,236 to Hartzler describes an electrically-conductive pulp of sulfonated polyaniline blended with para-aramid wherein the para-aramid is a continuous phase in the pulp and the sulfonated polyaniline is a discontinuous phase.

U.S. Pat. No. 5,882,566 to Hsu describes a method to make electrically conductive high strength and high modulus para-aramid fibers by spinning, from a lyotropic spin solution, filaments comprising para-aramid and sulfonic acid in situ ring-substituted polyaniline.

### SUMMARY OF THE INVENTION

This invention pertains to an electrically conductive pulp suitable for use as a reinforcement comprising from 60 to 96 weight percent of fibers of aromatic polyamide, aromatic copolyamide or mixtures thereof and from 4 to 40 weight percent of conductive material coated onto the fibers wherein the conductive material comprises
(i) a polymer of aniline, or
(ii) a random copolymer formed from aniline and one or more substituted aniline co-monomers that exist in the protonated emeraldine salt form.

### DETAILED DESCRIPTION

### Pulp

Pulp is a highly fibrillated fiber product that is manufactured from yarn by chopping the yarn into staple then mechanically abrading in water to partially shatter the fibers. Para-aramid fibers are particularly suited for the manufacture of pulp due to their high tenacity and fibrillar morphology. U.S. Pat. Nos. 5,084,136 and 5,171,402 describe such para-aramid pulps. Para-aramid fiber products are available under the tradename Kevlar® from E. I. du Pont de Nemours and Company, Wilmington, Del. (DuPont). Para-aramid fibers are converted into pulp to give a large increase in surface area as fibrils with diameters as low as 0.1 micrometer are attached to the surface of the main fibers, which are typically 12 micrometers in diameter. Typically, para-aramid pulp has a specific surface area of from 7 to 11 m²/g although values in the range of 4.2 to 15 m²/g have been reported. If they are to be highly dispersible in water or different matrices, para-aramid pulp must be kept moist to prevent the fibrillar morphology from collapsing. Preferably, the pulp fiber length is in the range of from 0.5 to 1.1 mm or even in the range of from 0.6 to 0.8 mm when determined as a Kajaani weight average length. Para-aramid fibers and pulps can be converted into micropulps by wet milling to increase their surface area as described in United States Patent Publication 2003/0114641 A1. Typically, micropulp has a specific surface area of from 15 to 80 m²/g with a fiber length of from 10 to 100 micrometers.

Para-aramid pulps are used as fillers in elastomer compounds to modify their tensile properties. A large application is in natural rubber for tire reinforcement. The moist pulps are dispersed into water and mixed with elastomer latexes then coagulated to give concentrated masterbatches such as Kevlar® Engineered Elastomer (EE). The EE masterbatches contain the pulp in a highly dispersed state that can be compounded into bulk elastomer to give the desired level of pulp modification. This process is further described in U.S. Pat. Nos. 5,830,395 and 6,068,922. Dry pulps are difficult to disperse directly into elastomers and remain agglomerated.

### Aromatic Polyamide

Para-aramid, an aromatic polyamide, is a suitable polymer for the fibers of the pulp. The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968.

A preferred para-aramid is poly (p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T, also means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Another suitable fiber is one based on aromatic copolyamide prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl) benzimidazole with terephthalic acid or anhydrides or acid chloride derivatives of these monomers.

### Conductive Material

Polyamide pulp as described above can be rendered electrically conductive by coating the fibers of the pulp with a conductive material produced by the oxidative polymerization of aniline such that from 60 to 96 weight percent of the pulp are fibers and from 4 to 40 weight percent of the pulp is electrically conductive coating, based on the total weight of fibers plus coating. Preferably, the coating material comprises a polymer of aniline or a random copolymer formed from aniline and one or more substituted anilines that exist in the protonated emeraldine salt form. This aniline polymer or copolymer is also referred to as PANI. In some embodiments, the aniline is the unsubstituted parent compound:

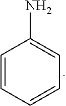

In some other embodiments, the aniline is a mixture of:

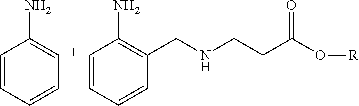

where R contains one or more sites of unsaturation or a mixture of aniline and one of more substituted polyfunctional aniline co-monomers that can serve to crosslink the conductive polyaniline coating.

Suitable polyfunctional aniline co-monomers include:

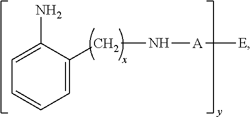

wherein
(i) x is an integer of 1 to 4,
(ii) y is an integer of 2 to 4,
(iii) A is

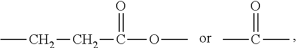

and
(iv) E is selected from the group consisting of:
a) CH₂ₙ
   when y=2 and where n is an integer from 1 to 200,

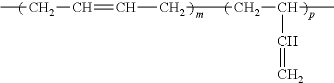

b)
   when y=2 and where m+p is an integer from 1 to 200,
c) —CH₂—CH₂O—CH₂—CH₂_{q}
   when y=2 and where q is an integer from 1 to 20,

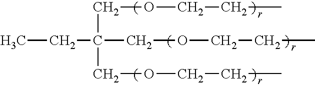

d)
   when y=3 and where r is an integer from 0 to 5,
e)

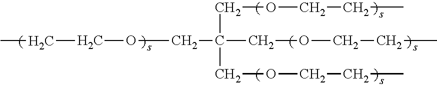

when y=4 and where s is an integer from 0 to 5,
f)

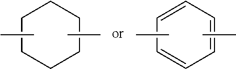

when y=2, and
g)

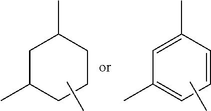

when y=3.

Other suitable aniline derivatives for use as co-monomers in processes to give random PANI copolymers with pendant functional groups are those with substitution in the ortho position. Chemical substituents can include “hydrophilic” groups that aid in the aqueous dispersibility of the PANI-pulp complex.

In one embodiment of an aniline co-monomer mixture, the parent aniline is used in an amount of at least 90 mol % and the substituted aniline(s) used in an amount of no greater than 10 mol %.

### Method of Making the Electrically Conductive Pulp

A method of making an electrically conductive fibrous pulp suitable for use as a reinforcement wherein the fibers are aromatic polyamide, aromatic copolyamide or mixtures thereof, comprises the steps of

(i) forming a suspension of pulp in an aqueous acid dopant,

(ii) adding aniline or aniline and at least one substituted aniline co-monomer to the suspension such that the weight percent ratio of the amount of aniline, or the amount of aniline and substituted aniline co-monomers, to the amount of pulp is in the range of from 4 to 40,

(iii) adding an initiator to the dispersion in the amount of one molar equivalent relative to aniline, or one molar equivalent relative to aniline and substituted aniline co-monomers, to effect polymerization,

(iv) stirring the pulp suspension for a sufficient time to ensure precipitation of the desired amount of aniline polymer or random copolymer onto the surface of the pulp,

(v) filtering the suspension to isolate the coated pulp product in a first filtration step,

(vi) washing the coated pulp product with additional aqueous acid dopant solution, and

(vii) isolating the washed coated pulp product in a second filtration step.

Optionally, the polyaniline coated pulp product of step (vii) may be dried under vacuum to remove water and other volatile by-products. In one embodiment, the sequence of steps (ii) and (iii) above may be reversed.

When the oxidative polymerization reaction described above is carried out in the presence of dispersed para-aramid or co-polyamide pulp, the pulp fibers in the aqueous medium become coated with the conductive polyaniline (PANI) polymer. Surprisingly and unexpectedly, the modified pulp remains well dispersed even when relatively high loadings of PANI (up to 40 wt % relative to pulp) are deposited out in this manner. The relative amounts of PANI deposited onto the fiber surfaces can be controlled by adjusting the starting aniline monomer-to-pulp ratio. Preferably, the PANI polymer is present in an amount of from 4 to 40 weight percent of the total weight of coated pulp. By varying the amount of aniline monomer relative to the amount of suspended pulp, the “thickness” of the conducting PANI layer on the pulp can be controlled.

In some embodiments, the surface of the para-aramid pulp can be partially hydrolyzed prior to forming a suspension in an aqueous acid dopant. Preferably, this partial hydrolysis is carried out in 10% sodium hydroxide for 1 hour to 24 hours at room temperature followed by washing to a pH 7 and generates reactive amine sites on the fiber surfaces via hydrolysis of some individual polyaramide chains. It is believed that the hydrolysis reaction roughens up the polyaramide surface, thus enhancing the adsorption of the polyaniline layer to the substrate. The newly formed free amine sites can also serve as “starting points” for the subsequent aniline polymerization reaction, resulting in PANI chains that are now covalently tied, as opposed to just physically bound, to the fiber surfaces.

The acid dopant is a strong acid such as hydrochloric acid, dodecyl benzene sulfonic acid or camphorsulfonic acid. Other protonic acids are also suitable.

In some embodiments, a preferred polymerization initator is ammonium persulfate, potassium persulfate or hydrogen peroxide or mixtures thereof.

In another embodiment, the polymerization reaction involving aniline or involving a mixture of aniline with at least one other substituted aniline co-monomer is initially run in the acid dopant medium devoid of suspended pulp to generate discrete particles of PANI or the PANI copolymer. A suspension of pulp is then added to this mixture. In some embodiments, the pulp suspension is added after about an hour. The polymerization reaction continues to occur, with the new PANI that is formed depositing out onto the pulp surfaces. Many of the particles that were generated earlier tend to remain “free” and are physically mixed with the coated pulp product.

### Composite Material

Electrically conductive pulp as described above may be used as a component of a composite material.

In one embodiment, the pulp is formed into a nonwoven sheet such as a veil or paper in which the fibers are randomly oriented. This sheet is then combined with a matrix resin and/or an adhesive. Other types of reinforcing fabrics or tapes may also be present.

In another embodiment, the pulp may be blended with a matrix resin or adhesive.

### EXAMPLES

### Examples 1-3 Describe the Preparation of Aniline Co-Monomers that are Suitable for Forming Crosslinked PANI Compositions

### Example 1

The following example details the synthesis of a water soluble aniline co-monomer containing two polymerizable aniline end groups.

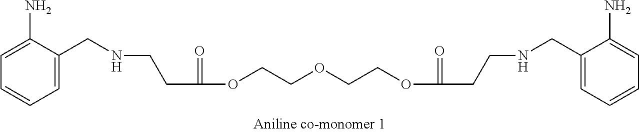 [SMILES: Nc1ccccc1CNCCC(=O)OCCOCCOC(=O)CCNCc1ccccc1N]

2-Aminomethyl aniline (22.8 g, 0.187 mol) dissolved in tetrahydrofuran (100 mL) was added dropwise over a 50 minute period to a chilled (0° C.) solution of diethylene glycol diacrylate (20.0 g, 0.093 mol; 0.187 mol reactive acrylate groups) in tetrahydrofuran (100 mL). After the addition was complete, the light yellow reaction mixture was allowed to warm to room temperature and then stirred for an additional 72 hour period. The reaction mixture was concentrated in vacuo to give a light orange colored oil.

Analysis of the product by ¹H NMR spectroscopy (CDCl₃) showed a complete absence of proton resonances for starting acrylate end groups (5.7-6.5 ppm) and the presence of new signals at 6.6 and 7.1 ppm (aromatic ring; C₆H₄), 5.9 ppm (aromatic amine; H₂N—C₆H₄) and 3.8 ppm (methylene; C₆H₄—CH₂—NH—) due to the newly placed, terminal aniline moieties. FTIR spectroscopy (neat) confirmed the inclusion of primary and secondary amine groups in the product, with new resonances appearing in the IR spectrum near 3422 and 3316 cm⁻¹.

### Example 2

The following example details the synthesis of an aniline co-monomer fitted with two polymerizable aniline end groups and an internal polybutadiene linker containing double bond sites that can co-cure with rubber during the vulcanization step.

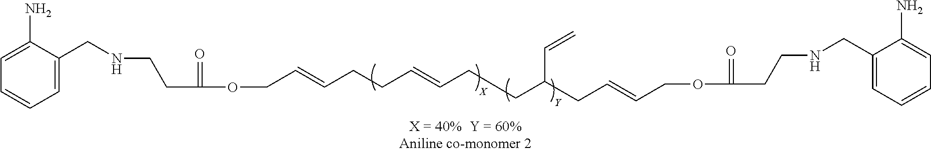

2-Aminomethyl aniline (6.75 g, 0.055 mol) dissolved in tetrahydrofuran (80 mL) was added dropwise to a solution of Sartomer CN-307 polybutadiene di-acrylate (36 g, 0.055 mol reactive acrylate groups) in tetrahydrofuran (200 mL) over a 10 minute period at room temperature. After the addition was complete, the light tan reaction mixture was stirred for an additional 48 hour period and then concentrated in vacuo to give a viscous, dark-brown oil. The crude product was redissolved into chloroform (200 mL) and extracted with 1% HCl (100 mL), water (3×100 mL) and finally brine (50 mL) and then dried over anhydrous sodium sulfate. After removal of the drying agent by filtration, the solution was concentrated in vacuo to give the final bis-aniline product as a gold colored oil.

Analysis of the product by ¹H NMR spectroscopy (CDCl₃) showed a complete absence of proton resonances for starting acrylate end groups (5.5-6.4 ppm) and the presence of new signals at 6.6 and 7.1 ppm (aromatic ring; C₆H₄), 5.9 ppm (aromatic amine; H₂N—C₆H₄) and 3.8 ppm (methylene; C₆H₄—CH₂—NH—) due to the newly placed, terminal aniline moieties. FTIR spectroscopy (neat) confirmed the inclusion of primary and secondary amine groups in the product, with new resonances appearing in the IR spectrum near 3442 and 3319 cm⁻¹. Additionally, size exclusion chromatography (SEC) indicated that the molecular weight of the bis-aniline product was roughly comparable to that of the butadiene di-acrylate starting material and that unwanted side reactions that might have produced higher molecular weight adducts did not take place during the Michael conjugate addition process.

### Example 3

The following example details the synthesis of a water soluble aniline co-monomer containing three polymerizable aniline end groups.

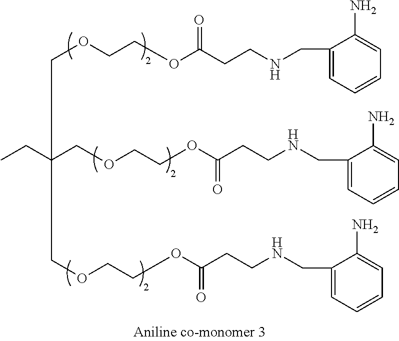

2-Aminomethyl aniline (30.1 g, 0.246 mol) dissolved in tetrahydrofuran (110 mL) was added dropwise to a solution of Sartomer SR-499 tri-acrylate (35.2 g, 0.247 mol reactive acrylate groups) in tetrahydrofuran (150 mL) over a 22 minute period at room temperature. After the addition was complete, the light tan reaction mixture was stirred under ambient conditions for a total of four days and then concentrated in vacuo to give a viscous, dark-brown oil. The crude product was warmed to 50 degrees C. and then placed under high vacuum to remove traces of unreacted 2-aminomethyl aniline starting material by the process of sublimation. The final bis-aniline product isolated as a dark gold-colored oil.

Analysis of the product by ¹H NMR spectroscopy (CDCl₃) showed a near absence of proton resonances for starting acrylate end groups (5.5-6.4 ppm) and the presence of new signals near 6.6 and 7.1 ppm (aromatic ring; C₆H₄), 4.6 ppm (aromatic amine; H₂N—C₆H₄) and 3.8 ppm (methylene; C₆H₄—CH₂—NH—) due to the newly placed, terminal aniline moieties. FTIR spectroscopy (neat) confirmed the inclusion of primary and secondary amine groups in the product, with new resonances appearing in the IR spectrum near 3442 and 3319 cm⁻¹.

### Examples 4-6 Describe the Preparation of PANI-Coated Aramid Pulps

### Example 4

This example demonstrates the oxidative polymerization of aniline in the presence of an aqueous suspension of para-aramid pulp to give a PANI-coated pulp product.

Hydrated para-aramidpulp (5.0 g; 50 wt % water) was suspended in 1 N HCl (500 mL) and allowed to stir rapidly for one hour. Aniline monomer (1.00 g, 10.7 mmol) was then added to the stirred suspension. After five additional minutes, the stirred suspension was treated with a solution of ammonium persulfate initiator (2.45 g, 10.7 mmol) dissolved in water (50 mL). The resulting mixture was stirred at room temperature for 24 hours during which time the suspended pulp fibers changed color from tan to dark green-blue. The PANI coated pulp product was isolated by filtration, re-suspended in 1 N HCl (500 mL) and then rapidly stirred for 20 minutes to remove any unbound reagents or materials. The final product was isolated by a second filtration step and then dried in vacuo at 50 C for 24 h. The dried PANI-coated pulp was re-dispersible in water or in a 1N HCl solution after vigorously stirring for several minutes.

### Example 5

This example demonstrates the oxidative copolymerization of a mixture of aniline and aniline co-monomer 1 in the presence of an aqueous suspension of para-aramid pulp to give a PANI-coated pulp product.

Hydrated para-aramid pulp (5.0 g; 50 wt % water) was suspended in 1 N HCl (700 mL) and allowed to stir rapidly overnight. A solution of aniline monomer (0.75 g, 8.05 mmol) dissolved into 1 N HCl (10 mL) was added to the suspension. A second solution of aniline co-monomer 1 (0.25 g, 0.545 mmol, 1.09 mmol reactive aniline groups) dissolved into 1 N HCl (10 mL) was also added to the stirred suspension. After fifteen minutes, the stirred suspension was treated with a solution of ammonium persulfate initiator (2.09 g, 9.16 mmol) dissolved in water (50 mL). The resulting mixture was stirred at room temperature for 27 hours during which time the suspended pulp fibers changed color from tan to dark green. The PANI coated pulp product was isolated by filtration, re-suspended in 1 N HCl (600 mL) and then rapidly stirred for one hour to remove any unbound reagents or materials. The final product was isolated by a second filtration step and then dried in vacuo at 50 C for 36 h. The dried PANI-coated pulp was re-dispersible in water or in a 1N HCl solution after vigorously stirring for several minutes.

### Example 6

This example demonstrates the oxidative copolymerization of a mixture of aniline and the organo-soluble aniline co-monomer 2 in the presence of an aqueous suspension of para-aramid pulp to give a PANI-coated pulp product.

Hydrated para-aramid pulp (5.0 g; 50 wt % water) was suspended in 1 N HCl (800 mL) and allowed to stir rapidly for one hour. A solution of aniline co-monomer 2 (1.00 g) dissolved into 1,4-dioxane (20 mL) was added to the suspension in a drop-wise manner over a 15 minute period. The resulting mixture was stirred for another 30 minutes to allow the aniline co-monomer 2 to evenly coat-out onto the pulp fibers. A second solution of aniline monomer (0.88 g, 9.44 mmol) dissolved into 1 N HCl (10 mL) was also added to the stirred suspension. After fifteen minutes, the stirred suspension was treated with a solution of ammonium persulfate initiator (2.45 g, 10.7 mmol) dissolved in water (15 mL). The resulting mixture was stirred at room temperature for 24 hours during which time the suspended pulp fibers changed color from tan to dark green. The PANI coated pulp product was isolated by filtration, re-suspended in 1 N HCl (500 mL) and then rapidly stirred for about one hour to remove any unbound reagents or materials. The final product was isolated by a second filtration step and then dried in vacuo at 50 C for 36 hours. The dried PANI-coated pulp was re-dispersible in water or in a 1N HCl solution after vigorously stirring for several minutes.

### Example 7

This example compares the relative solvent stabilities of the three PANI-coated pulp products prepared in Examples 4, 5 and 6.

General Test Procedure.

PANI-coated aramid pulp samples (0.10 g each) were placed into screw-capped glass vials and then treated with equivalent volumes of water, methanol, 1,4-dioxane or N,N-dimethyl-acetamide (DMAC) (10 mL). The capped vials containing the test mixtures were placed on a nutating platform and gently agitated for one hour. The contents of the vials were then allowed to settle and the relative amount of PANI removed from each of the coated pulps was qualitatively judged by examining the color of the fluid surrounding the aramid pulp fibers. A clear fluid indicated that the PANI coating exhibited good solvent stability and remained bound to the pulp surface. A light green-colored fluid indicated that some of the PANI coating was removed from the pulp. A dark green solution indicated that most of the PANI coating was dissolved from the pulp fibers by the test fluid.

TABLE 1

| Product | Crosslinking | | | | |
|---|---|---|---|---|---|
| from | aniline co- | | | | |
| Example | monomer | | | 1,4- | |
| # | used | Water | Methanol | dioxane | DMAC |
| 4 | none | clear | clear | light | dark |
| | | | | green | green |
| 5 | 1 | clear | clear | clear | clear |
| 6 | 2 | clear | clear | clear | light |
| | | | | | green |

The results summarized in Table 1 confirm that the use of aniline co-monomers 1 and 2 in the oxidative polymerization reaction of aniline furnished PANI coated pulp products with enhanced solvent stabilities, even when tested against an aggressive solvent like DMAC. Aniline co-monomer 1 was more effective than co-monomer 2 when qualitatively evaluated in this manner.

### Example 8

This example demonstrates the oxidative polymerization of aniline in a 1N HCl solution where an aqueous suspension of para-aramid pulp is added at a latter stage to give a final product that contains a mixture of PANI particles and PANI-coated pulp.

Aniline monomer (1.00 g, 10.7 mmol) and ammonium persulfate initiator (2.45 g, 10.7 mmol) were both dissolved in 1N HCl (300 mL). The resulting solution was stirred at room temperature for one hour during which time it became turbid and dark green in color. Para-aramid pulp (5.0 g; 50 wt % water) that had been pre-suspended in 1 N HCl (250 mL) was then rapidly added to the reaction mixture. The resulting heterogeneous mixture was stirred at room temperature for an additional 23 hours during which time the suspended pulp fibers changed color from tan to dark green-blue. The product was isolated by filtration, re-suspended in 1 N HCl (500 mL) and then rapidly stirred for 20 minutes to remove any residual reagents. The final product was isolated by a second filtration step and then dried in vacuo at 50 degrees C. for 24 hours.

Analysis of the product mixture by Scanning Electron Microscopy (SEM) revealed the presence of small discrete particles that were randomly mixed among the larger pulp fibers. This observation was in direct contrast to an SEM analysis on the PANI coated pulp product isolated from Example 4 which showed a complete absence of particles. The dried product containing the mixture of PANI particles and PANI coated pulp was re-dispersible in water or in a 1N HCl solution after vigorously stirring for several minutes.

### Example 9

This example compares electrical resistance values measured for the PANI-coated aramid pulp prepared in Example 4 to those determined for an uncoated aramid pulp control sample.

Preparation of Test Specimens:

The dried PANI-coated aramid pulp product prepared in Example 4 (5.0 g) was re-suspended into 1 N HCl (500 mL) with gentle stirring. An aliquot of this suspension (80-100 mL) was then slowly passed through a 30 mL glass-fritted filter funnel. After the filtration was complete, the product, now shaped into a small rounded fibrous disk, was carefully removed from the filter funnel using plastic-covered tweezers. This procedure was repeated two additional times, giving a total of three separate sample disks. The disks were dried to constant weight in an argon-purged vacuum oven set to 45 degrees C. A similar procedure was carried out for uncoated aramid pulp, giving three additional disks that would serve as controls. All of the oven dried disks prepared in this manner had diameters that ranged from 28-30 mm and thickness values that fell between 5-7 mm.

Measurement of Electrical Resistance Values:

Each of the small disks prepared above was pre-treated with Flash-Dry Silver Paint (SPI Supplies, a Division of Structure Probe Inc., West Chester, Pa.). The paint was applied to two small (approximately 1 mm diameter) regions on the top surface of each disk. The painted regions were separated by a linear distance of 20 mm. The disks modified in this manner were dried in a vacuum oven for one hour. Two-point electrical resistance measurements were then made by carefully attaching electrical leads to the two silver-painted regions on each disk. Resistance values were determined with a standard volt-ohm multi-meter (Ideal Industries, Sycamore, Ill.).

The three PANI-coated pulp test specimens evaluated in this manner were electrically conductive, exhibiting electrical resistance values that ranged from 10-50 K ohm. In stark contrast, the uncoated aramid pulp controls were totally insulating, displaying infinitely high resistance values when evaluated in the same manner.

What is claimed is:

1. An electrically conductive pulp suitable for use as a reinforcement comprising from 60 to 96 weight percent of fibers selected from the group consisting of aromatic polyamide, aromatic copolyamide and mixtures thereof and from 4 to 40 weight percent of conductive material coated onto the fibers, wherein the conductive material comprises
(i) a polymer of aniline, or
(ii) a random copolymer formed from aniline and one or more substituted aniline co-monomers that exist in the protonated emeraldine salt form.

2. The pulp of claim 1, comprising polyaniline particles blended with pulp, the pulp comprising a coating of polyaniline on the fiber surfaces.

3. The pulp of claim 1, comprising particles of a random copolymer formed from aniline and one or more substituted aniline co-monomers blended with pulp, the pulp comprising a coating of a random copolymer formed from aniline and one or more substituted aniline co-monomers.

4. The pulp of claim 1, wherein the aromatic polyamide is para-aramid.

5. A method of making an electrically conductive fibrous pulp suitable for use as a reinforcement, the fibers being selected from the group consisting of aromatic polyamide, aromatic copolyamide and mixtures thereof, comprising the steps of
(i) forming a suspension of pulp in an aqueous acid dopant,
(ii) adding aniline or aniline and at least one substituted aniline co-monomer to the suspension such that the weight percent ratio of the amount of aniline, or the amount of aniline and substituted aniline co-monomers, to the amount of pulp is in the range of from 4 to 40,
(iii) adding an initiator to the dispersion in the amount of one molar equivalent relative to aniline, or one molar equivalent relative to aniline and substituted aniline co-monomers, to effect polymerization,
(iv) stirring the pulp suspension for a sufficient time to ensure precipitation of the desired amount of aniline polymer or random copolymer onto the surface of the pulp,
(v) filtering the suspension to isolate the coated pulp product in a first filtration step,
(vi) washing the coated pulp product with additional aqueous acid dopant solution, and
(vii) isolating the washed coated pulp product in a second filtration step.

6. The method of claim 5, wherein the acid dopant is selected from the group consisting of hydrochloric acid, dodecyl benzene sulfonic acid and camphorsulfonic acid.

7. The method of claim 5, wherein the initiator is selected from the group consisting of ammonium persulfate, potassium persulfate and hydrogen peroxide.

8. The method of claim 5, wherein aniline is selected from the group consisting of the unsubstituted parent compound: 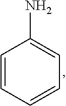
a mixture of aniline and one or more substituted aniline co-monomers: 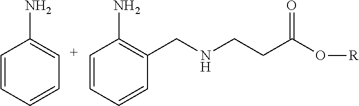
where R contains one or more sites of unsaturation
and a mixture of aniline and one or more substituted polyfunctional aniline co-monomers that can serve to crosslink the conductive polyaniline coating.

9. The method of claim 5, wherein the surface of the para-aramid pulp has been partially hydrolyzed prior to forming a suspension in an aqueous acid dopant.

10. The method of claim 5, comprising drying the coated pulp product of step (vii) under vacuum to remove water and other volatile by-products.

11. The method of claim 5, wherein the aromatic polyamide is para-aramid.

12. The method of claim 8, wherein the substituted polyfunctional aniline co-monomers are 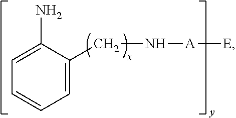
wherein
(i) x is an integer of 1 to 4,
(ii) y is an integer of 2 to 4,
(iii) A is 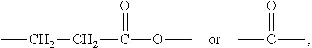
and
(iv) E is selected from the group consisting of:
a) CH₂ₙ
when y=2 and where n is an integer from 1 to 200,
b) 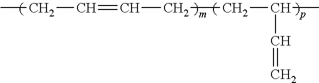
when y=2 and where m+p is an integer from 1 to 200,
c) —CH₂—CH₂O—CH₂—CH₂_{q}
when y=2 and where q is an integer from 1 to 20,
d) 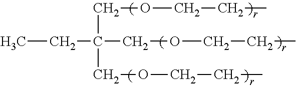
when y=3 and where r is an integer from 0 to 5,
e) 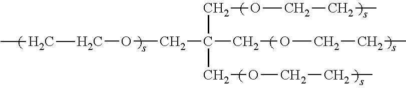
when y=4 and where s is an integer from 0 to 5,
f) 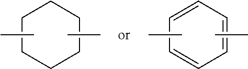
when y=2, and
g) 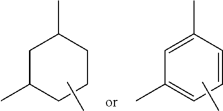
when y=3.

13. The method of claim 8, wherein in an aniline co-monomer mixture, the parent aniline is used in an amount of at least 90 mol % and the substituted aniline co-monomers(s) used is in an amount of no greater than 10 mol %.

14. The method of claim 9, wherein the hydrolysis of the pulp is carried out in 10% sodium hydroxide for 1 hour to 24 hours at room temperature followed by washing to a pH of 7.

15. A substituted polyfunctional aniline co-monomer having the formula 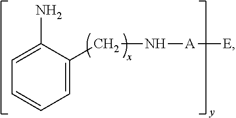
wherein
(i) x is an integer of 1 to 4,
(ii) y is an integer of 2 to 4,
(iii) A is 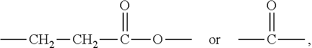
and
(iv) E is selected from the group consisting of:
a) CH₂ₙ
when y=2 and where n is an integer from 1 to 200,
b) 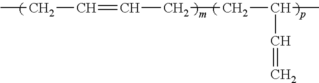
when y=2 and where m+p is an integer from 1 to 200,
c) —CH₂—CH₂—O—CH₂—CH₂_{q}
when y=2 and where q is an integer from 1 to 20,
d) 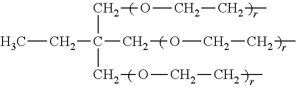
when y=3 and where r is an integer from 0 to 5,
e) 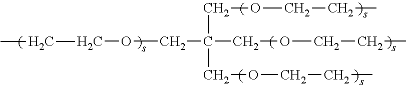
when y=4 and where s is an integer from 0 to 5,
f) 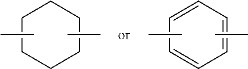
when y=2, and
g) 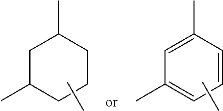
when y=3.

16. A composite material comprising the electrically conductive pulp of claim 1 formed into a nonwoven sheet and blended with a matrix resin.

17. The composite material of claim 16, wherein the nonwoven sheet is blended with an adhesive.
